(19) United States
(12) Patent Application Publication
(10) Pub. No.: US 2016/0301107 A1
(43) Pub. Date: Oct. 13, 2016

(54) FUNCTIONALIZED PERFLUOROALKANES AND ELECTROLYTE COMPOSITIONS

(71) Applicant: Blue Current, Inc., Berkeley, CA (US)

(72) Inventors: Alexander Teran, Oakland, CA (US); Benjamin Rupert, Berkeley, CA (US); Eduard Nasybulin, Fremont, CA (US); Joanna Burdynska, Berkeley, CA (US)

(21) Appl. No.: 15/012,515

(22) Filed: Feb. 1, 2016

Related U.S. Application Data
(60) Provisional application No. 62/144,298, filed on Apr. 7, 2015.

(51) Int. Cl. H01M 10/0569; H01M 10/0564; H01M 10/0567; H01M 10/0525; H01M 10/0568

(52) U.S. Cl. CPC H01M 10/0569; H01M 10/0525; H01M 10/0568; H01M 10/0567; H01M 10/0564; H01M 2220/10; H01M 2220/20; H01M 2300/0034; H01M 2300/0065

(57) ABSTRACT

Provided herein are functionally substituted fluoropolymers suitable for use in liquid and solid non-flammable electrolyte compositions. The functionally substituted fluoropolymers include perfluoroalkanes (PFAs) having high ionic conductivity. Also provided are non-flammable electrolyte compositions including functionally substituted PFAs and alkali-metal ion batteries including the non-flammable electrolyte compositions.

### CROSS-REFERENCE TO RELATED APPLICATION

This application claims the benefit under 35 U.S.C. §119(e) to U.S. Provisional Application 62/144,298, titled “FUNCTIONALIZED PERFLUOROALKANES,” filed Apr. 7, 2015, the entirety of which is incorporated herein by reference for all purposes.

### BACKGROUND

Lithium-ion (Li-ion) and other alkali metal salt batteries are of great interest as a renewable energy source. Li-ion batteries are the dominant secondary battery for consumer electronics, and have potential for other applications such as energy storage. However, commercially available Li-ion batteries typically include electrolytes having high volatility and flammability. In faulty batteries or batteries exposed to extreme conditions, these electrolytes can cause serious fires. These safety concerns limit the use of Li-ion battery technology in fields that use large-scale batteries including home and grid storage and transportation applications.

### SUMMARY

One aspect of the disclosure may be implemented in a functionalized perfluoroalkane according to Formula I or Formula II:

R_{f}—Xₒ—R′ (I)

R″—Xₘ—R_{f}—Xₒ—R′ (II)

wherein ‘R_{f}’ is a perfluoroalkane backbone; X is an alkyl, fluoroalkyl, ether, or fluoroether group, wherein ‘m’ and ‘o’ are each independently zero or an integer ≧1; and R″ and R′ are each independently selected from the group consisting of aliphatic, alkyl, aromatic, heterocyclic, amide, carbamate, carbonate, sulfone, phosphate, phosphonate, or nitrile containing groups. In some aspects, the perfluoroalkanes described herein have a number average molecular weight of about 200 g/mol to about 5,000 g/mol. In some aspects, the perfluoroalkanes described herein have a group (X) as defined by Formula I and Formula II comprising an alkyl group.

In some embodiments, the one or more groups of the perfluoroalkanes described herein may comprise one or more carbonate containing groups, e.g., linear carbonate groups. In one aspect, the one or more linear carbonate groups comprises a moiety represented by structure S1,

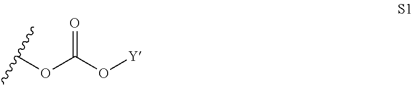

wherein Y′ is selected from the group consisting of aliphatic, alkyl, aromatic, heterocyclic, amide, carbamate, carbonate, sulfone, phosphate, phosphonate, or nitrile containing groups. In one aspect, the perfluoroalkanes described herein comprising one or more terminal end groups is selected from the group consisting of structures S12-S15.

In some embodiments, the one or more carbonate containing groups of the perfluoroalkanes described herein may comprise one or more cyclic carbonate groups. In one aspect, the cyclic carbonate group comprises a moiety represented by structure S10,

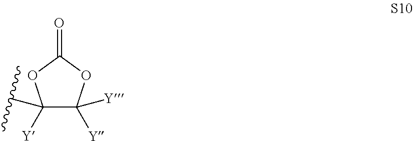

wherein Y′, Y″, and Y′″ are each independently selected from the group consisting of an aliphatic, alkyl, aromatic, heterocyclic, amide, carbamate, carbonate, sulfone, phosphate, phosphonate, or nitrile containing group, or a hydrogen atom or a halogen atom.

Another aspect of the disclosure may be implemented in methods of making a perfluoroalkane having a linear carbonate group. The methods involve (a) flushing a reaction vessel with an inert gas; (b) adding a hydroxyl terminated perfluorocarbon, trimethylamine, and 1,1,1,3,3-pentafluorobutane or tetrahydrofuran to said reaction vessel, wherein trimethylamine is present as one equivalent per hydroxyl group; (c) mixing the solution resulting from steps (a) and (b) and adding methyl chloroformate to form said perfluoroalkane having one or more linear carbonate groups; and (d) isolating said perfluoroalkane having one or more linear carbonate groups.

Another aspect of the disclosure may be implemented in methods of making a perfluoroalkane having a cyclic carbonate group. The methods involve (a) adding a hydroxyl terminated perfluorocarbon, sodium hydroxide and epichlorohydrin to a reaction vessel, wherein sodium hydroxide is present as one equivalent per hydroxyl group to form a mixture; (b) heating the mixture of step (a) to 60° C. overnight to form an epoxide terminated perfluorocarbon; (c) isolating the epoxide terminated perfluorocarbon of step (b); (d) adding the isolated epoxide terminated perfluorocarbon of step (c) to a reaction vessel comprising a mixture comprising: (i) methyltriphenylphosphonium iodide or phosphonium iodide; and (ii) 1-methoxy-isopropanol or isopropanol; (e) pressurizing the reaction vessel of step (d) with carbon dioxide to form the cyclic carbonate terminated perfluoroalkane; and (f) isolating the cyclic carbonate terminated perfluoroalkane.

Another aspect of the disclosure may be implemented in a non-flammable liquid or solid electrolyte composition, which may comprise any perfluoroalkane as described herein and an alkali metal salt. In some aspects, the perfluoroalkane may comprise from about 30% to about 85% of the non-flammable liquid or solid electrolyte composition. In some aspects, the alkali metal salt may comprise a lithium salt or a sodium salt. In one aspect, the alkali metal salt is a lithium salt comprising LiPF₆ or LiTFSI or a mixture thereof. In another aspect, LiPF₆ or LiTFSI or a mixture thereof comprises about 15% to about 35% of the non-flammable liquid or solid electrolyte composition.

In some embodiments, the non-flammable liquid or solid electrolyte compositions described herein may further comprise at least one of a conductivity enhancing additive, viscosity reducer, a high voltage stabilizer, or a wettability additive, or a mixture or combination thereof.

In some embodiments, the conductivity enhancing additive may comprise ethylene carbonate (EC), propylene carbonate (PC), butylene carbonate (BC), fluoroethylene carbonate, vinylene carbonate (VC), dimethylvinylene carbonate (DMVC), vinylethylene carbonate (VEC), divinylethylene carbonate, phenylethylene carbonate, or diphenylethylene carbonate or a mixture or combination thereof. In one aspect, the conductivity enhancing agent comprises ethylene carbonate.

In some embodiments described herein, the conductivity enhancing additive may comprise about 1% to about 40% of the non-flammable liquid or solid electrolyte composition.

In some embodiments, the high voltage stabilizer may comprise 3-hexylthiophene, adiponitrile, sulfolane, lithium bis(oxalato)borate, γ-butyrolactone, 1,1,2,2-tetrafluoro-3-(1,1,2,2-tetrafluoroethoxy)-propane, ethyl methyl sulfone, or trimethylboroxine or a mixture or combination thereof.

In some embodiments, the wettability additive may comprise triphenyl phosphite, dodecyl methyl carbonate, methyl 1-methylpropyl carbonate, methyl 2,2-dimethylpropanoate, or phenyl methyl carbonate or a mixture or combination thereof.

In some embodiments, the viscosity reducer, high voltage stabilizer, and wettability additives described herein may each independently comprise about 0.5-6% of the non-flammable liquid or solid electrolyte composition.

In some embodiments, the non-flammable liquid or solid electrolyte compositions described herein have an ionic conductivity of from 0.01 mS/cm to about 10 mS/cm at 25° C.

In some embodiments, the non-flammable liquid or solid electrolyte composition described herein does not ignite when heated to a temperature of about 150° C. and subjected to an ignition source for at least 15 seconds.

In some embodiments, the non-flammable liquid or solid electrolyte composition has a flash point greater than 100° C. In some embodiments, the non-flammable electrolyte composition has a flash point greater than 110° C. In some embodiments, the non-flammable electrolyte composition has a flash point greater than 120° C. In some embodiments, the non-flammable electrolyte composition has self-extinguishing time of zero. In some embodiments, the non-flammable electrolyte composition does not ignite when heated to a temperature of about 150° C. and subjected to an ignition source for at least 15 seconds. In some embodiments, the non-flammable electrolyte composition has an ionic conductivity of from 0.01 mS/cm to about 10 mS/cm at 25° C.

One embodiment described herein is a battery comprising: (a) an anode; (b) a separator; (c) a cathode; and (d) any non-flammable liquid or solid electrolyte composition described herein.

### BRIEF DESCRIPTION OF THE DRAWINGS

FIG. 1 Ionic conductivity of perfluoroalkane based electrolyte solutions across a range of temperatures

FIG. 2 Ionic conductivity of perfluoroalkane electrolyte based solutions at different concentrations of LiTFSI

FIG. 3 Anodic scan cyclic voltammetry data of perfluoroalkane based electrolyte solutions

FIG. 4 Cathodic scan cyclic voltammetry data of perfluoroalkane based electrolyte solutions

### DETAILED DESCRIPTION

The following paragraphs define in more detail the embodiments of the invention described herein. The following embodiments are not meant to limit the invention or narrow the scope thereof, as it will be readily apparent to one of ordinary skill in the art that suitable modifications and adaptations may be made without departing from the scope of the invention, embodiments, or specific aspects described herein.

Described herein are novel functionally substituted fluoropolymers, non-flammable electrolyte compositions, and alkali metal ion batteries. Also described herein are methods for manufacturing the fluoropolymers and compositions described herein.

For purposes of interpreting this specification, the following terms and definitions will apply and whenever appropriate, terms used in the singular will also include the plural and vice versa. In the event that any definition set forth below conflicts with any document incorporated herein by reference, the definition set forth below shall control.

The term “alkyl” as used herein alone or as part of another group, refers to a straight or branched chain hydrocarbon containing any number of carbon atoms, including from 1 to 10 carbon atoms, 1 to 20 carbon atoms, or 1 to 30 or more carbon atoms and that include no double or triple bonds in the main chain. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. “Lower alkyl” as used herein, is a subset of alkyl and refers to a straight or branched chain hydrocarbon group containing from 1 to 4 carbon atoms. Representative examples of lower alkyl include, but are not limited to, methyl, ethyl, n-propyl, iso-propyl, n-butyl, iso-butyl, tert-butyl, and the like. The term “alkyl” or “lower alkyl” is intended to include both substituted and unsubstituted alkyl or lower alkyl unless otherwise indicated.

The term “cycloalkyl” as used herein alone or as part of another group, refers to a saturated or partially unsaturated cyclic hydrocarbon group containing from 3, 4 or 5 to 6, 7 or 8 carbons (which carbons may be replaced in a heterocyclic group as discussed below). Representative examples of cycloalkyl include cyclopropyl, cyclobutyl, cyclopentyl, cyclohexyl, cycloheptyl, and cyclooctyl. These rings may be optionally substituted with additional substituents as described herein such as halo or lower alkyl. The term “cycloalkyl” is generic and intended to include heterocyclic groups unless specified otherwise, with examples of heteroatoms including oxygen, nitrogen and sulfur

The term “alkoxy” as used herein alone or as part of another group, refers to an alkyl or lower alkyl group, as defined herein, appended to the parent molecular moiety through an oxy group, —O—. Representative examples of alkoxy include, but are not limited to, methoxy, ethoxy, propoxy, 2-propoxy, butoxy, tert-butoxy, pentyloxy, hexyloxy and the like. In some aspects, alkoxy groups, when part of a more complex molecule, comprise an alkoxy substituent attached to an alkyl or lower alkyl via an ether linkage.

The term “halo” as used herein refers to any suitable halogen, including —F, —Cl, —Br, and —I.

The term “cyano” as used herein refers to a CN group.

The term “formyl” as used herein refers to a —C(O)H group.

The term “hydroxyl” as used herein refers to an —OH group.

The term “sulfoxyl” as used herein refers to a compound of the formula —S(O)R, where R is any suitable substituent such as alkyl, cycloalkyl, alkenyl, alkynyl or aryl.

The term “carbonate” as used herein alone or as part of another group refers to a —OC(O)OR radical, where R is any suitable substituent such as aryl, alkyl, alkenyl, alkynyl, cycloalkyl or other suitable substituent as described herein.

The term “cyclic carbonate” as used herein refers to a heterocyclic group containing a carbonate.

The term “ester” as used herein alone or as part of another group refers to a —C(O)OR radical, where R is any suitable substituent such as alkyl, cycloalkyl, alkenyl, alkynyl or aryl.

The term “ether” as used herein alone or as part of another group refers to a —COR radical where R is any suitable substituent such as alkyl, cycloalkyl, alkenyl, alkynyl, or aryl.

The term “phosphate” as used herein refers to a —OP(O)ORₐOR_{b} radical, where Rₐ and R_{b} are independently any suitable substituent such as alkyl, cycloalkyl, alkenyl, alkynyl or aryl or a hydrogen atom.

The term “phosphone” as used herein refers to a —P(O)ORₐOR_{b} radical, where Rₐ and R_{b} are independently any suitable substituent such as alkyl, cycloalkyl, alkenyl, alkynyl or aryl or a hydrogen atom.

The term “nitrile” as used herein refers to a —C≡N group.

The term “sulfonate” as used herein refers to a —S(O)(O)OR radical, where R is any suitable substituent such as alkyl, cycloalkyl, alkenyl, alkynyl or aryl.

The term “sulfone” as used herein refers to a —S(O)(O)R radical, where R is any suitable substituent such as alkyl, cycloalkyl, alkenyl, alkynyl or aryl.

The term “fluoropolymer” as used herein alone or as part of another group refers to a branched or unbranched fluorinated chain including two or more C—F bonds. The term “perfluorinated” as used herein refers to a compound or part thereof that includes C—F bonds and no C—H bonds. The term perfluoropolymer as used herein alone or as part of another group refers to a fluorinated chain that includes multiple C—F bonds and no C—H bonds.

Examples include but are not limited to fluoroalkanes, perfluoroalkanes, fluoropolyethers, and perfluoropolyethers, poly(perfluoroalkyl acrylate), poly(perfluoroalkyl methacrylate), polytetrafluoroethylene, polychlorotrifluoroethylene, polyvinylidene fluoride, and copolymers of any of the forgoing. See, e.g., U.S. Pat. No. 8,361,620; 8,158,728 (DeSimone et al.); and U.S. Pat. No. 7,989,566.

It should be noted that in some embodiments the fluoropolymers described herein are significantly smaller than conventional polymers, which contain many repeated sub-units.

The term “perfluoroalkane” (PFA) refers to an alkane, wherein all available C—H bonds have been converted to a C—F bond. Linear perfluoroalkanes may be represented by the general formula C—F₂ₙ₊₂ and cyclic perfluoroalkanes may be represented by C—F₂—, wherein ‘n’ represents the number of carbon atoms in a given structure. Methods of fluorinating alkanes and general perfluoroalkane structures are also known. See, for example, Sanford, Perfluoroalkanes. Tetrahedron 59 (2003) 437-454, which is incorporated by reference herein for its teachings thereof.

The term “perfluoropolyether” or PFPE as used herein alone or as part of another group refers to a chain including two or more ether groups and no C—H bonds with the exception of C—H bonds that may be present at terminal groups of the chain. Examples include but are not limited to polymers that include a segment such as difluoromethylene oxide, tetrafluoroethylene oxide, hexafluoropropylene oxide, tetrafluoroethylene oxide-co-difluoromethylene oxide, hexafluoropropylene oxide-co-difluoromethylene oxide, or tetrafluoroethylene oxide-co-hexafluoropropylene oxide-co-difluoromethylene oxide and combinations thereof. See, e.g., U.S. Pat. No. 8,337,986, which is incorporated by reference herein for its teachings thereof. Additional examples include but are not limited to those described in P. Kasai et al., Applied Surface Science 51, 201-211 (1991); J. Pacansky and R. Waltman, Chem. Mater. 5, 486-494 (1993); K. Paciorek and R. Kratzer, Journal of Fluorine Chemistry 67, 169-175 (1994); M. Proudmore et al., Journal of Polymer Science: Part A: Polymer Chemistry, 33, 1615-1625 (1995); J. Howell et al., Journal of Fluorine Chemistry 125, 1513-1518 (2004); and in U.S. Pat. Nos. 8,084,405; 7,294,731; 6,608,138; 5,612,043; 4,745,009; and 4,178,465, each of which are incorporated by reference herein for their teachings thereof.

The term “inert gas” is known and generally refers to any gas which does not undergo a chemical reaction or react with a given set of substances in a chemical reaction. Non-limiting examples of inert gases useful for the methods and compositions described herein comprise a noble gas (i.e., helium, neon, argon, krypton, xenon, or radon), nitrogen, or water-free air, or a mixture or combination thereof. In some embodiments described herein, an inert gas is used in the methods of synthesizing a perfluoroalkane as described herein.

Uses of perfluoropolyethers (PFPEs) and PEO, and in particular cross-linked PFPEs and PEO have been described. See, International Patent Application Publication No. WO2014204547, which is incorporated by reference in its entirety herein.

The term “functionally substituted” as used herein refers to a substituent covalently attached to a parent molecule. In some aspects described herein, the parent molecule is a fluorinated alkane or perfluoroalkane as further described herein (e.g., with or without an additional linking group). In some aspects, the substituent comprises one or more polar moieties. In some aspects, the presence of the substituent (e.g., one or more polar moieties) functions to disassociate and coordinate alkali metal salts under certain conditions as further described herein.

The term “functionally substituted perfluoroalkane” refers to a compound including a PFA as described above and one or more functional groups covalently attached to the PFA. The functional groups may be directly attached to the PFA or attached to the PFA by a linking group. The functional groups and the linking groups, if present, may be non-fluorinated, partially fluorinated, or perfluorinated. The term “functionally substituted perfluoroalkane” is used interchangeably with “functionalized perfluoroalkane.”

The term “number average molecular weight” or “Mₙ” refers to the statistical average molecular weight of all molecules (e.g., perfluoroalkanes) in the sample expressed in units of g/mol. The number average molecular weight may be determined by techniques known in the art, such as gel permeation chromatography (wherein Mₙ can be calculated based on known standards based on an online detection system such as a refractive index, ultraviolet, or other detector), viscometry, mass spectrometry, or colligative methods (e.g., vapor pressure osmometry, end-group determination, or proton NMR). The number average molecular weight is defined by the equation below,

$${M}_{n} = \frac{\sum {N}_{i} {M}_{i}}{\sum {N}_{i}}$$

wherein Mᵢ is the molecular weight of a molecule and Nᵢ is the number of molecules of that molecular weight.

The term “weight average molecular weight” or “M_{w}” refers to the statistical average molecular weight of all molecules (e.g., perfluoroalkanes), taking into account the weight of each molecule in determining its contribution to the molecular weight average, expressed in units of g/mol. The higher the molecular weight of a given molecule, the more that molecule will contribute to the M_{w} value. The weight average molecular weight may be calculated by techniques known in the art which are sensitive to molecular size, such as static light scattering, small angle neutron scattering, X-ray scattering, and sedimentation velocity. The weight average molecular weight is defined by the equation below,

$${M}_{w} = \frac{\sum {N}_{i} {M}_{i}^{2}}{\sum {N}_{i} {M}_{i}}$$

wherein ‘Mᵢ’ is the molecular weight of a molecule and ‘Nᵢ’ is the number of molecules of that molecular weight.

The term “polydispersity index” or “PDI” refers to the breadth of the molecular weight distribution of a population of molecules (e.g., a population of perfluoroalkane molecules). The polydispersity index is defined by the equation below,

$$PDI = \frac{{M}_{w}}{{M}_{n}}$$

wherein ‘PDI’ is the ratio of the weight average molecular weight ‘M_{w},’ as described herein to the number average molecular weight ‘Mₙ’ as described herein. All molecules in a population of molecules (e.g., perfluoroalkanes) that is monodisperse have the same molecular weight and that population of molecules has a PDI or M_{w}/Mₙ ratio equal to 1.

The term “molar mass” refers to the mass of a chemical compound or group thereof divided by its amount of substance. In the below description, references to weight average molecular weight or number average molecular weight may be alternatively taken to be the molar mass of a single molecule or a population of molecules having a PDI of 1.

The term “non-flammable” as used herein means a compound or solution (e.g., an electrolyte solution) that does not easily ignite, combust, or catch fire.

The term “flame retardant” as used herein refers to a compound that is used to inhibit, suppress, or delay the spread of a flame, fire, or a combustion of one or more materials.

The term “substantially” as used herein means to a great or significant extent, but not completely. In some aspects, substantially means about 90% to 99% or more in the various embodiments described herein, including each integer within the specified range.

The term “about” as used herein refers to any value that is within a variation of up to ±10% of the value modified by the term “about.”

The term “at least about” as used herein refers to a minimum numerical range of values (both below and above a given value) that has a variation of up to ±10% of the value modified by the term “about.”

As used herein, “a” or “an” means one or more unless otherwise specified.

Terms such as “include,” “including,” “contain,” “containing,” “has,” or “having” and the like mean “comprising.”

The term “or” can be conjunctive or disjunctive.

### Functionally Substituted Perfluoroalkanes

In some embodiments, the functionally substituted perfluoroalkanes described herein comprise compounds of Formula I and Formula II:

R_{f}—Xₒ—R′ (I)

R″—Xₘ—R_{f}—Xₒ—R′ (II)

wherein:

R_{f}² is a perfluoroalkane backbone;

‘X’ is an alkyl, fluoroalkyl, ether, or fluoroether group, wherein ‘m’ and ‘o’ may each be independently zero or an integer ≧1; and

R′ and R″ are each independently functionally substituted aliphatic, alkyl, aromatic, heterocyclic, amide, carbamate, carbonate, sulfone, phosphate, phosphonate, or nitrile containing groups. In some aspects, the perfluoroalkane backbone (‘R_{f}’) according to Formula I and Formula II may have a number average molecular weight (Mₙ) from about 100 g/mol to 5,000 g/mol, including each integer within the specified range. In some aspects, the functionally substituted perfluoroalkane (i.e., R_{f}—Xₒ—R′ or R″—Xₘ—R_{f}—Xₒ—R′) according to Formula I and Formula II may have a Mₙ from about 150 g/mol to 5,000 g/mol, including each integer within the specified range.

In some embodiments, the functionally substituted perfluoroalkanes described herein comprise compounds of Formula III and Formula IV:

R_{f}—Xₒ—R′—(Xₜ—Rₐ)_{q} (III)

(R_{b}—Xₛ)ₚ—R″—Xₘ—R_{f}—Xₒ—R′—(Xₜ—Rₐ)_{q} (IV)

wherein:

R_{f} is a perfluoroalkane backbone;

X is an alkyl, fluoroalkyl, ether, or fluoroether group, wherein ‘s,’ ‘m’, ‘o’, and ‘t’ may each be independently zero or an integer ≧1; and

R′ and R″ and Rₐ and R_{b} are each independently functionally substituted aliphatic, alkyl, aromatic, heterocyclic, amide, carbamate, carbonate, sulfone, phosphate, phosphonate, or nitrile containing groups, wherein ‘p’ and ‘q’ may each be an integer ≧1.

In some aspects, the perfluoroalkane backbone (‘R_{f}’) according to Formula III and Formula IV may have a number average molecular weight (Mₙ) from about 100 g/mol to 5,000 g/mol, including each integer within the specified range. In some aspects, the functionally substituted perfluoroalkane (i.e., R_{f}—Xₒ—R′ or R″—Xₘ—R_{f}—Xₒ—R′) according to Formula III and Formula IV may have a Mₙ from about 150 g/mol to 5,000 g/mol, including each integer within the specified range. The perfluoroalkane backbone ‘R_{f}’ comprises at least one or more repeating moieties distributed in any order along a polymer chain to generate a linear perfluoroalkane backbone structure. Each independently repeating unit of the perfluoroalkane backbone comprises —(CFₓ)ₙ—, wherein ‘x’ is zero or an integer from 1-2 and ‘n’ is an integer ≧1, and each repeating unit is distributed in any order along the polymer chain.

Each repeating unit of the main linear perfluoroalkane backbone (e.g., ‘R_{f}’ of formulas I-IV) may be further substituted with one or more branching perfluorocarbon moieties to form a perfluorinated branched chain stemming from one or more carbons of the main perfluoroalkane backbone. The total perfluorinated branched chain stemming from the one or more carbons of the main linear perfluoroalkane backbone as described herein may be represented by the general formula —(CₙF₂ₙ₊ᵢ) wherein ‘n’ represents the total number of carbons in the branched structure and is an integer ≧1. For example, the main linear perfluoroalkane backbone may be substituted with one or more covalently bonded perfluorinated moieties in any order to form a branched chain stemming from the main linear perfluoroalkane backbone. Thus, in some aspects, one perfluorinated branched chain stemming from the main linear perfluoroalkane backbone may have one covalently bonded perfluorinated moiety covalently bonded to a second perfluorinated moiety, and the like, to generate a progressively larger branched perfluorinated chain stemming from the main linear perfluoroalkane backbone. Non-limiting examples of such branching perfluorinated moieties include —C(CFₓ)ₙ—, —(CFₓ)ₙ, or —(CF₃)ₙ, wherein ‘x’ is zero or an integer from 1-2 and ‘n’ is an integer ≧1, representing the number of independent branched fluorinated moieties. In addition, the linear perfluoroalkane backbone may be substituted with one or more cyclic or aromatic perfluorinated moieties stemming from the main perfluoroalkane backbone.

In some embodiments, the main linear perfluoroalkane backbone ‘R_{f}’ may comprise an exemplary and non-limiting unit represented by the structure according to Formula V,

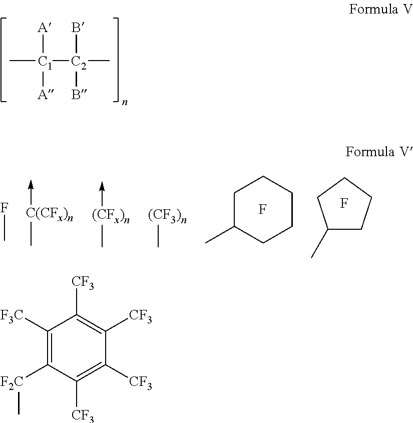

wherein A′, A″, B′, or B″ may independently be ‘F’ as shown in Formula V′ or one or more of the branching groups shown by Formula V′, wherein each instance of ‘n’ in the formulas above is independently an integer ≧1 and wherein ‘x’ is zero or an integer from 1-2. As described herein, the branching groups of Formula V′ may optionally form multiple covalently connected perfluorinated branching groups as indicated by the upward indicating bond arrow. Exemplary, non-limiting structures supported by Formula V and V′ are shown below,

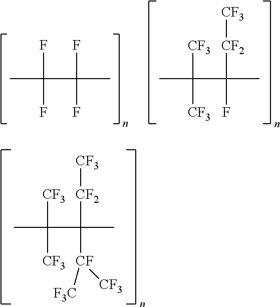

wherein ‘n’ is an integer ≧1.

In some embodiments, the functionally substituted linear perfluoroalkane comprises an exemplary and non-limiting structure according to Formula VI or Formula VII,

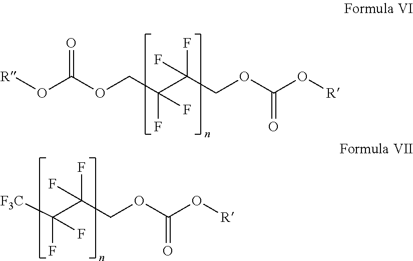

wherein R′ and R″ are each independently aliphatic, alkyl, aromatic, heterocyclic, amide, carbamate, carbonate, sulfone, phosphate, phosphonate, or nitrile containing groups and ‘n’ is an integer ≧1. In some aspects, the functionally substituted linear perfluoroalkane according to Formula VI and Formula VII may have a Mₙ from about 150 g/mol to 5,000 g/mol, including each integer within the specified range.

In some embodiments, the linear perfluoroalkane backbone (e.g., ‘R_{f}’) as described herein comprises at least two carbon atoms. In one aspect, the linear perfluoroalkane backbone may comprise between 2 and 100 carbon atoms, including each integer within the specified range. In another aspect, the linear perfluoroalkane backbone may comprise between 2 and 50 carbon atoms, including each integer within the specified range. In another aspect, the linear perfluoroalkane backbone comprises between 2 and 20 carbon atoms, including each integer within the specified range. In another aspect, the linear perfluoroalkane backbone comprises between 2 and 10 carbon atoms, including each integer within the specified range. In another aspect, the linear perfluoroalkane backbone comprises 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 or more carbon atoms.

In some embodiments, the linear perfluoroalkane backbone as described herein further comprises one or more branched perfluorinated moieties stemming from one or more of the carbon atoms of the linear perfluoroalkane backbone as described herein. In one aspect, the one or more branched perfluorinated chains stemming independently from one or more carbon atoms of the linear perfluorinated backbone may comprise between 1 and 20 carbon atoms, including each integer within the specified range. In another aspect, the one or more branched perfluorinated chains stemming independently from one or more carbon atoms of the linear perfluorinated backbone may comprise between 1 and 10 carbon atoms, including each integer within the specified range. In another aspect, the one or more branched perfluorinated chains stemming independently from one or more carbon atoms of the linear perfluorinated backbone may comprise between 1 and 5 carbon atoms, including each integer within the specified range. In another aspect, the one or more branched perfluorinated chains stemming independently from one or more carbon atoms of the linear perfluorinated backbone may comprise between 1 and 3 carbon atoms, including each integer within the specified range. In another aspect, the one or more branched perfluorinated chains stemming independently from one or more carbon atoms of the linear perfluorinated backbone may comprise 1, 2, 3, 4, 5, 6, 7, 8, 9, 10, 11, 12, 13, 14, 15, 16, 17, 18, 19, or 20 or more carbon atoms.

In some embodiments, the functionalized perfluoroalkane may comprise one or more carbamate, carbonate, sulfone, phosphate, phosphonate, or nitrile containing groups. In some embodiments, these groups may comprise any one of or a combination of any one of the moieties represented by structures S1-S11. In some embodiments, these groups maybe selected from the group consisting of the moieties represented by structures S1-S11. In some aspects, Y′, Y″, and Y′″ represent an additional aliphatic, alkyl, aromatic, heterocyclic, amide, carbamate, carbonate, sulfone, phosphate, phosphonate or nitrile containing groups as given in Formulas I-IV above. In some aspects, the moieties represented by these structures are covalently attached to the perfluoroalkane backbone as indicated by Formulas I-V′ above.

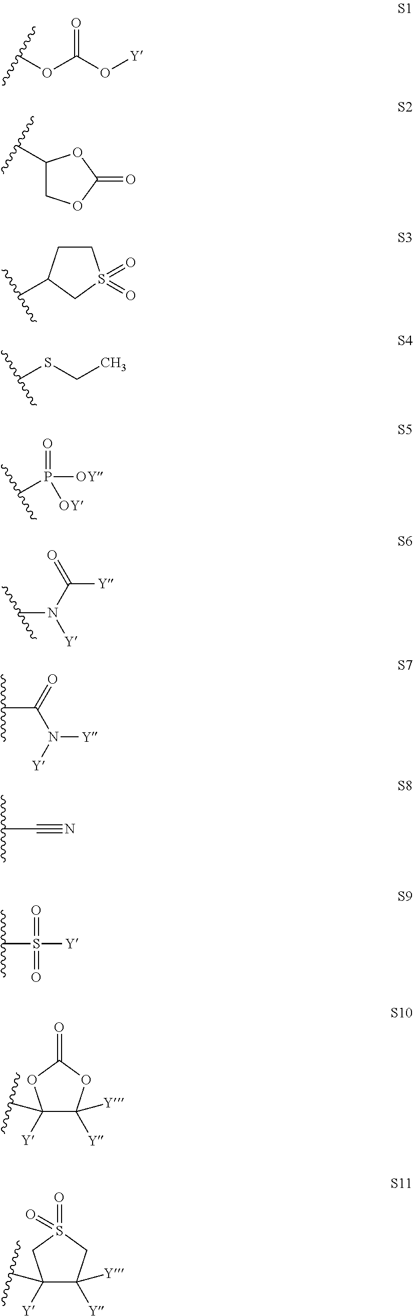

In some embodiments described herein, the functionalized perfluoroalkane may comprise between 1 and 10 of any one of or a combination of any one of the moieties represented by structures S1-S11, including each integer within the specified range. In some aspects, these structures are covalently attached to the perfluoroalkane backbone as indicated by Formulas I-V′ above. In some other aspects, the functionalized perfluoroalkane may comprise at least 1, at least 2, at least 3, or at least 4 or more of any one of or a combination of any one of structures S1-S11 covalently attached to the perfluoroalkane backbone as indicated by Formulas I-V′ above.

In some embodiments described herein, the functionalized perfluoroalkane (i.e., the perfluoroalkane backbone ‘R_{f}’ covalently attached to one or more groups as defined in Formulas I-V′) may have a number average molecular weight (Mₙ) of about 150 g/mol to about 5,000 g/mol, including each integer within the specified range. In some aspects, the functionalized perfluoroalkane may have a number average molecular weight of about 150 g/mol to about 2,000 g/mol, including each integer within the specified range. In some aspects, the functionalized perfluoroalkane may have a number average molecular weight of about 150 g/mol to about 1,500 g/mol, including each integer within the specified range. In some aspects, the functionalized perfluoroalkane may have a number average molecular weight of about 150 g/mol to about 1,000 g/mol, including each integer within the specified range. In some aspects, the functionalized perfluoroalkane may have a number average molecular weight of about 150 g/mol to about 500 g/mol, including each integer within the specified range. In some aspects, the functionalized perfluoroalkane may have a number average molecular weight of about 150 g/mol to about 300 g/mol, including each integer within the specified range. In some aspects, the functionalized perfluoroalkane may have a number average molecular weight of at least about 150 g/mol, at least about 200 g/mol, at least about 250 g/mol, at least about 300 g/mol, at least about 350 g/mol, at least about 400 g/mol, at least about 450 g/mol, at least about 500 g/mol, at least about 550 g/mol, at least about 600 g/mol, at least about 650 g/mol, at least about 700 g/mol, at least about 750 g/mol, at least about 800 g/mol, at least about 850 g/mol, at least about 900 g/mol, at least about 950 g/mol, at least about 1,000 g/mol, at least about 1,100 g/mol, at least about 1,200 g/mol, at least about 1,300 g/mol, at least about 1,400 g/mol, at least about 1,500 g/mol, at least about 1,600 g/mol, at least about 1,700 g/mol, at least about 1,800 g/mol, at least about 1,900 g/mol, at least about 2,000 g/mol, at least about 2,250 g/mol, at least about 2,500 g/mol, at least about 2,750 g/mol, at least about 3,000 g/mol, at least about 3,250 g/mol, at least about 3,500 g/mol, at least about 3,750 g/mol, at least about 4,000 g/mol, at least about 4,250 g/mol, at least about 4,500 g/mol, at least about 4,750 g/mol, or at least about 5,000 g/mol.

In some embodiments described herein, the functionalized perfluoroalkane (i.e., the perfluoroalkane backbone ‘R_{f}’ covalently attached to one or more groups as defined in Formulas I-V′) may have a weight average molecular weight (M_{w}) of about 150 g/mol to about 5,000 g/mol, including each integer within the specified range. In some aspects, the functionalized perfluoroalkane may have a weight average molecular weight of about 150 g/mol to about 2,000 g/mol, including each integer within the specified range. In some aspects, the functionalized perfluoroalkane may have a weight average molecular weight of about 150 g/mol to about 1,500 g/mol, including each integer within the specified range. In some aspects, the functionalized perfluoroalkane may have a weight average molecular weight of about 150 g/mol to about 1,000 g/mol, including each integer within the specified range. In some aspects, the functionalized perfluoroalkane may have a weight average molecular weight of about 150 g/mol to about 500 g/mol, including each integer within the specified range. In some aspects, the functionalized perfluoroalkane may have a weight average molecular weight of about 150 g/mol to about 300 g/mol, including each integer within the specified range. In some aspects, the functionalized perfluoroalkane may have a weight average molecular weight of at least about 150 g/mol, at least about 200 g/mol, at least about 250 g/mol, at least about 300 g/mol, at least about 350 g/mol, at least about 400 g/mol, at least about 450 g/mol, at least about 500 g/mol, at least about 550 g/mol, at least about 600 g/mol, at least about 650 g/mol, at least about 700 g/mol, at least about 750 g/mol, at least about 800 g/mol, at least about 850 g/mol, at least about 900 g/mol, at least about 950 g/mol, at least about 1,000 g/mol, at least about 1,100 g/mol, at least about 1,200 g/mol, at least about 1,300 g/mol, at least about 1,400 g/mol, at least about 1,500 g/mol, at least about 1,600 g/mol, at least about 1,700 g/mol, at least about 1,800 g/mol, at least about 1,900 g/mol, at least about 2,000 g/mol, at least about 2,250 g/mol, at least about 2,500 g/mol, at least about 2,750 g/mol, at least about 3,000 g/mol, at least about 3,250 g/mol, at least about 3,500 g/mol, at least about 3,750 g/mol, at least about 4,000 g/mol, at least about 4,250 g/mol, at least about 4,500 g/mol, at least about 4,750 g/mol, at least about 5,000 g/mol, at least about 5,500 g/mol, at least about 6,000 g/mol, at least about 6,500 g/mol, at least about 7,000 g/mol, at least about 7,500 g/mol, at least about 8,000 g/mol, at least about 8,500 g/mol, at least about 9,000 g/mol, at least about 9,500 g/mol, or at least about 10,000 g/mol.

In some embodiments described herein, the functionalized perfluoroalkane (i.e., the perfluoroalkane backbone ‘R_{f}’ covalently attached to one or more groups as defined in Formulas I-V′) may have a polydispersity index (PDI) of about 1 to about 20. In some aspects, the functionalized perfluoroalkane may have a polydispersity index of about 1 to about 10. In some aspects, the functionalized perfluoroalkane may have a polydispersity index of about 1 to about 5. In some aspects, the functionalized perfluoroalkane may have a polydispersity index of about 1 to about 2. In some aspects, the functionalized perfluoroalkane may have a polydispersity index of about 1 to about 1.5. In some aspects, the functionalized perfluoroalkane may have a polydispersity index of about 1 to about 1.25. In some aspects, the functionalized perfluoroalkane may have a polydispersity index of about 1 to about 1.1. In some aspects, the functionalized perfluoroalkane may have a polydispersity index of about 1, less than about 1.05, less than about 1.1, less than about 1.15, less than about 1.2, less than about 1.25, less than about 1.5, less than about 1.75, less than about 2, less than about 2.25, less than about 2.5, less than about 2.75, less than about 3, less than about 3.5, less than about 4, less than about 4.5, less than about 5, less than about 6, less than about 7, less than about 8, less than about 9, less than about 10, less than about 11, less than about 12, less than about 13, less than about 14, less than about 15, less than about 16, less than about 17, less than about 18, less than about 19, or less than about 20.

In one embodiment, the functionalized perfluoroalkane may comprise a linear methyl carbonate structure as shown in structure S12-S14. As shown below, in certain such embodiments, two linear methyl carbonate groups are covalently attached to the perfluoroalkane backbone with an alkyl (CH₂) group as provided by Formulas II, V, and VI described above.

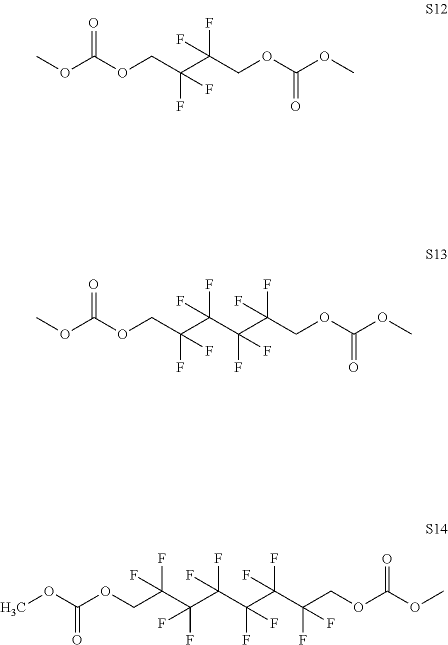

In another embodiment, the functionalized perfluoroalkane may comprise a linear methyl carbonate structure as shown in structure S15. As shown below, one linear methyl carbonate group is covalently attached to the perfluoroalkane backbone with an alkyl (CH₂) group as provided by Formulas II, V, and VI described above.

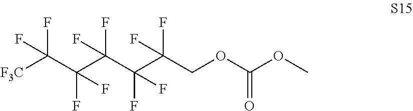 [SMILES: COC(=O)OCC(F)(F)C(F)(F)C(F)(F)C(F)(F)C(F)(F)C(F)(F)F]

In another embodiment, the functionalized perfluoroalkane may comprise a cyclic carbonate structure as shown in structure S16 and S17. As shown below in structure S16, two cyclic carbonate groups are covalently attached to the perfluoroalkane backbone with an alkyl (CH₂) group, whereas structure S17 has two cyclic carbonate groups covalently attached to the perfluoroalkane backbone with a substituted alkyl group (e.g., an alkoxy-substituted alkyl; CH₂OCH₂) as provided by Formulas II, V, and VI described above.

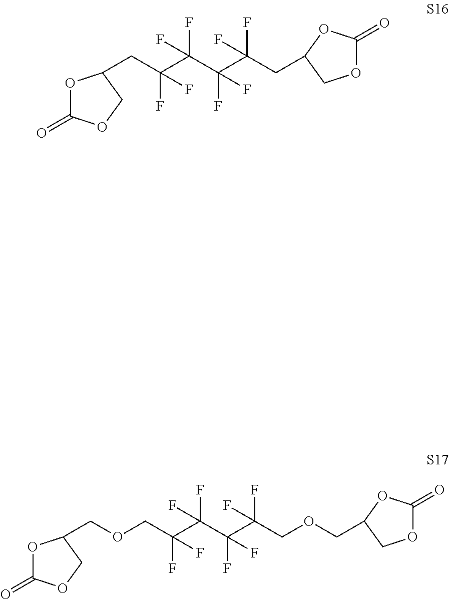 [SMILES: O=C1OCC(CC(F)(F)C(F)(F)C(F)(F)C(F)(F)CC2COC(=O)O2)O1 ; O=C1OCC(COCC(F)(F)C(F)(F)C(F)(F)C(F)(F)COCC2COC(=O)O2)O1]

In another embodiment, the functionalized perfluoroalkane may comprise a cyclic carbonate structure as shown in structure S18 and S19. As shown below in structures S18, one cyclic carbonate group is covalently attached to the perfluoroalkane backbone with an alkyl (CH₂) group, whereas structure S19 has one cyclic carbonate terminal end group covalently attached to the perfluoroalkane backbone with a substituted alkyl group (e.g., an alkoxy-substituted alkyl; CH₂OCH₂) as provided by Formulas II, V, and VI described above.

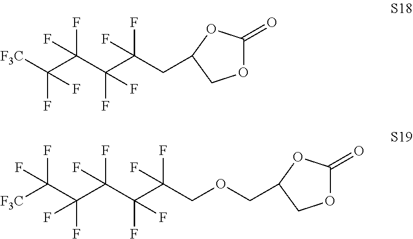

In another embodiment, the functionalized perfluoroalkane may comprise a linear carbonate linked to a cyclic carbonate structure as shown in structure S20. As shown below, one cyclic carbonate group is covalently attached to a linear carbonate, which is linked to the perfluoroalkane backbone with an alkyl (CH₂) group as provided by Formulas III, V, and VII described above.

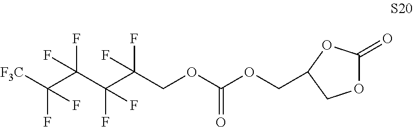 [SMILES: O=C(OCC1COC(=O)O1)OCC(F)(F)C(F)(F)C(F)(F)C(F)(F)C(F)(F)F]

Further branching of the perfluoroalkane backbone may be incorporated into any one of the embodied structures described herein as further exemplified by Formula V and V′.

In some embodiments, the functionally substituted fluoropolymers disclosed herein are mono-functional as in the examples of Formula I. It has been found that for some embodiments of relatively small molecular weight functionally substituted fluoropolymers, mono-functional functionally substituted fluoropolymers may have significantly higher conductivities than their di-functional counterparts, despite having fewer ion coordinating groups. This is discussed further with respect to Example 6 below. Without being bound by a particular theory, it is believed that the increase in conductivity is due to the sharp decrease in viscosity observed for the mono-functional fluoropolymers. For relatively large functionally substituted fluoropolymers (e.g., MW of 1000 g/mol and above), the difference between mono-functional and di-functional functionally substituted fluoropolymers is not expected to be as significant.

In some aspects, a perfluoroalkane backbone R_{f} covalently attached to one or more groups as described in Formulas I-IV has a molar mass or number average molecular weight from about 100 g/mol to 450 g/mol, including each integer within the specified range. In some aspects, R_{f} has a molar mass or number average molecular weight from about 100 g/mol to 400 g/mol, including each integer within the specified range. In some aspects, R_{f} has a molar mass or number average molecular weight from about 100 g/mol to 350 g/mol including each integer within the specified range. In some aspects, R_{f} has a molar mass or number average molecular weight 100 g/mol to 300 g/mol, including each integer within the specified range. In some aspects, R_{f} has a molar mass or number average molecular weight 100 g/mol to 250 g/mol, including each integer within the specified range. In some aspects, R_{f} has a molar mass or number average molecular weight 100 g/mol to 200 g/mol, including each integer within the specified range.

In some embodiments, R_{f} includes a linear PFA backbone having between 3 and 9 carbon atoms including each integer in the specified range. For example, the linear PFA backbone may have between 3 and 8 carbon atoms, or between 3 and 7 carbon atoms, or between 3 and 6 carbon atoms, or between 3 and 5 atoms. In another aspect the linear PFA backbone comprises 3, 4, 5, 6, 7, 8, or 9 carbon atoms. If branched, the linear PFA may additionally incorporate one or more branched perfluorinated chains stemming independently from one or more carbon atoms of the linear PFA backbone as described above, each of which branched chains may have between 1 and 5 carbon atoms, including each integer within the specified range.

In some embodiments, a PFA backbone R_{f} covalently attached to one or more groups as described in Formulas I-IV is unbranched, or if branched, has no branch points within two molecules (along the R_{f}—X—R′ or R″—Xₘ—R_{f}—X—R′ chain) of the functional group on R′ or R″ of Formulas I and II. In some embodiments, a branched PFA backbone R_{f} has no branch points within three molecules, four molecules, five molecules, or six molecules of the functional group on R′ or R″ of Formulas I and II.

In some embodiments, R′ and R″ as disclosed in Formulas I and II have a lower alkyl end group, e.g., R′ or R″ may be methyl carbonate, ethyl carbonate, propyl carbonate, methyl phosphate, ethyl phosphate, etc. In some embodiments, R′ and R″ as disclosed in Formulas I and II are non-fluorinated. Fluorine is electron withdrawing such that the presence of fluorine on R′ or R″ can reduce conductivity. Further, fluorine close to the carbonate may be unstable. If R′ or R″ is partially fluorinated, any F may be at least two or three molecules away from the carbonate or other functional group of R′ or R″.

In some embodiments, the functional end group substituted perfluoroalkanes as described herein serve to coordinate alkali metal ions and exhibit chemical and thermal stability. Without being bound by any theory, the substitution of lable C—H bonds with C—F bonds significantly increases resistance of molecules towards oxidation (e.g., burning), thus the high fluorine content reduces or prevents the likelihood of combustion. Further, in some embodiments, the functional end group substituted perfluoroalkanes coordinate alkali metal ions, allowing for the dissolution of alkali metal salts, and the conduction of ions in electrolyte mixtures. In some aspects, branching structures within the backbone of the perfluoroalkane may decrease the relative viscosity of the solution.

In some embodiments, the perfluoroalkane may have a linear, a branched, or a linear and partially branched perfluorinated alkane backbone as described herein. In some embodiments, the perfluoroalkane may incorporate any one or more of the functional groups as described herein (e.g., structures S1-S11). Such modifications of the perfluoroalkane solvent molecules bring flexibility in terms of physicochemical properties, enabling tuning of the electrolyte characteristics and delivering desired performance of alkali-metal batteries.

The functionally substituted PFA's disclosed herein may have the following characteristics: low viscosity, non-flammability, accessible functional groups to dissociate and coordinate alkali metal salts, relatively high ionic conductivity, and stability. In some embodiments, the viscosity is less than about 10 cP at 20° C. and 1 atm, or less than about 6 cP at 20° C. and 1 atm. Low viscosity may be due to mono-functionality and relatively low molecular weights of the functionally substituted PFA as disclosed above.

In some embodiments, the conductivity of a functionally substituted PFA in 1.0M LiTFSI is at least 0.01 mS/cm at 25° C., at least 0.02 mS/cm at 25° C., at least 0.03 mS/cm at 25° C., at least 0.04 mS/cm at 25° C., or at least 0.05 mS/cm at 25° C.

In some embodiments, the substituted fluoropolymers according to Formula VIII have a flash point and SET of zero in addition to having the viscosities and/or conductivities described above.

Any of the PFA's disclosed herein may be modified to form partially fluorinated fluoropolymers. For example, one or more CF₃ or CF₂ groups of the PFA's disclosed herein may be modified to form CHF₂, CH₂F, CHF, or CH₂, with the distribution of hydrogen along the R_{f} chain managed to avoid flammability. Such partially fluorinated fluoropolymers may be formed from the PFA or by any other known synthetic route.

### Electrolyte Compositions

Some embodiments described herein are electrolyte compositions comprising a functionally substituted perfluoroalkane as described herein. In some aspects, the electrolyte composition comprises a mixture or combination of functionally substituted perfluoroalkanes as described herein. In some aspects, the electrolyte composition is useful in an alkali-metal ion battery. In some aspects, the addition of electrolyte additives may improve battery performance, facilitate the generation of a solid electrolyte interface (i.e., an SEI) on electrode surfaces (e.g., on a graphite based anode), enhance thermal stability, protect cathodes from dissolution and overcharging, and enhance ionic conductivity.

In some embodiments, the electrolyte solutions described herein comprise an alkali metal salt and a functionally substituted perfluoroalkane as described herein. In some aspects, the electrolyte solution may optionally further comprise one or more conductivity enhancing additives, one or more SEI additives, one or more viscosity reducers, one or more high voltage stabilizers, and/or one or more wettability additives. In some aspects, the electrolyte solutions described herein comprise the composition shown in Table 1.

TABLE 1
Exemplary Fluoropolymer Electrolyte System

| Component | Exemplary Components | Composition Range (%) |
|---|---|---|
| Alkali-metal salt | Lithium salt (e.g., LiPF₆ or LiTFSI), Sodium | 15-35 |
| | salt, Potassium salt, etc. | |
| Func. subst. | PFA-carbonate (e.g., PFA-methyl carbonate), | 30-85 |
| perfluoroalkane (PFA) | etc. | |
| Conductivity enhancing | Ethylene carbonate, Fluoroethylene | 1-40 |
| additive(s) | carbonate, Vinylethylene carbonate, | |
| | trispentafluorophenyl borane, lithium | |
| | bis(oxalato)borate, etc. | |
| Opt. SEI additive(s) | Ethylene carbonate, Vinyl carbonate, Vinyl | 0.5-6 |
| | ethylene carbonate, Fluoroethylene | |
| | carbonate, etc. | |
| Opt. Viscosity reducer(s) | perfluorotetraglyme, γ-butyrolactone, | 0.5-6 |
| | trimethylphosphate, dimethyl | |
| | methylphosphonate, difluoromethylacetate, | |
| | fluoroethylene carbonate (FEC), vinylene | |
| | carbonate (VC), etc. | |
| Opt. High voltage | 3-hexylthiophene, adiponitrile, sulfolane, | 0.5-6 |
| stabilizer(s) | lithium bis(oxalato)borate, γ-butyrolactone, | |
| | 1,1,2,2-Tetrafluoro-3-(1,1,2,2- | |
| | tetrafluoroethoxy)-propane, ethyl methyl | |
| | sulfone, trimethylboroxine, etc. | |
| Opt. Wettability additive | Non-ionic or ionic surfactant, | 0.5-6 |
| | fluorosurfactant, etc. | |
| Opt. Flame retardant | trimethylphosphate, triethylphosphate, | 0.5-20 |
| | triphenylphosphate, trifluoroethyl | |
| | dimethylphosphate, | |
| | tris(trifluoroethyl)phosphate, etc. | |

Electrolyte compositions described herein can be prepared by any suitable technique, such as mixing a functionally substituted perfluoroalkane as described above after polymerization thereof with an alkali metal ion salt, and optionally other ingredients, as described below, in accordance with known techniques. In the alternative, electrolyte compositions can be prepared by including some or all of the composition ingredients in combination with the reactants for the preparation of the perfluoroalkanes prior to reacting the same.

When other ingredients are included in the homogeneous solvent system, in general, the functionally substituted perfluoroalkane is included in the solvent system in a weight ratio to all other ingredients (e.g., polyether, polyether carbonates) of from 40:60, 50:50, 60:40, or 70:30, up to 90:10, 95:5, or 99:1, or more.

In some embodiments, the electrolyte compositions comprise an SEI additive. In some aspects, the addition of SEI additives prevents the reduction of the perfluoroalkane electrolytes described herein and increases the full cycling of batteries. In some aspects, films of SEI additives maybe coated onto graphite surfaces prior to any cycling to form an insoluble preliminary film. In some aspects, SEI additives form films on graphite surfaces during the first initial charging when the electrolyte compositions described herein are used in a battery. Suitable SEI additives comprise polymerizable monomers, and reduction-type additives.

Non-limiting examples include vinylene carbonate, vinyl ethylene carbonate, allyl ethyl carbonate, vinyl acetate, divinyl adipate, acrylic acid nitrile, 2-vinyl pyridine, maleic anhydride, methyl cinnamate, phosphonate, 2-cyanofuran, or additional vinyl-silane-based compounds or a mixture or combination thereof. In addition, sulfur-based reductive type additives may be used including sulfur dioxide, poly sulfide containing compounds, or cyclic alkyl sulfites (e.g., ethylene sulfite, propylene sulfite, and aryl sulfites). Other reductive additives including nitrates and nitrite containing saturated or unsaturated hydrocarbon compounds, halogenated ethylene carbonate (e.g., fluoroethylene carbonate), halogenated lactones (e.g., α-bromo-γ-butyrolactone), and methyl chloroformate. In addition, SEI formation maybe initiated by use of carbon dioxide as a reactant with ethylene carbonate and propylene carbonate electrolytes. Additional SEI forming additives may include carboxyl phenols, aromatic esters, aromatic anhydrides (e.g., catechol carbonate), succinimides (e.g., benzyloxy carbonyloxy succinimide), aromatic isocyanate compounds, boron based compounds, such as trimethoxyboroxin, trimethylboroxin, bis(oxalato)borate, difluoro(oxalato)borate, or tris(pentafluorophenyl) borane, or mixture or combination thereof. Further examples of SEI additives are taught by U.S. Patent App. Pub No. 2012/0082903, which is incorporated by reference herein.

In some embodiments, the electrolyte compositions comprise one or more flame retardants. Non-limiting examples of flame retardants may include trimethylphosphate (TMP), triethylphosphate (TEP), triphenyl phosphate (TPP), trifluoroethyl dimethylphosphate, tris(trifluoroethyl)phosphate (TFP) or mixture or combination thereof. While the electrolyte solutions described herein are non-flammable, in some embodiments described herein, one or more flame retardants may be used to prevent, suppress, or delay the combustion of adjacent non-electrolyte materials (e.g., surrounding battery materials).

In some embodiments, the electrolyte compositions comprise a wetting agent. In some aspects, the wetting agent comprises an ionic or non-ionic surfactant or low-molecular weight cyclic alkyl compound (e.g., cyclohexane) or an aromatic compound. Other fluoro containing surfactants may be used. See, U.S. Pat. No. 6,960,410, which is incorporated by reference herein for its teachings thereof.

In some embodiments, the electrolyte compositions comprise a non-aqueous conductivity enhancing additive. It is thought that the presence of even small amounts of a polar conductivity enhancer aids in the disassociation of alkali metal salts and increases the total conductivity of electrolyte mixtures. This may reduce ohmic drop from a decreased bulk resistence in the electrochemical cells of batteries and enable cycling at higher densities. The conductivity enhancing additive may include, for example, one or more cyclic carbonates, acyclic carbonates, fluorocarbonates, cyclic esters, linear esters, cyclic ethers, alkyl ethers, nitriles, sulfones, sulfolanes, siloxanes, and/or sultones.

Cyclic carbonates that are suitable include ethylene carbonate (EC), propylene carbonate (PC), butylene carbonate (BC), fluoroethylene carbonate and the like. Additional examples may include a cyclic carbonate having a C═C unsaturated bond, such as vinylene carbonate (VC), dimethylvinylene carbonate (DMVC), vinylethylene carbonate (VEC), divinyl ethyl ene carbonate, phenyl ethylene carbonate, di phenyl ethylene carbonate, or any combination thereof. Suitable cyclic esters include, for example γ-butyrolactone (GBL), α-methyl-γ-butyrolactone, γ-valerolactone; or any combination thereof. Examples of a cyclic ester having a C═C unsaturated bond include furanone, 3-methyl-2(5H)-furanone, α-angelicalactone, or any combinations thereof. Cyclic ethers include tetrahydrofuran, 2-methyltetrahydrofuran, tetrahydropyran and the like. Alkyl ethers include dimethoxyethane, diethoxyethane and the like. Nitriles include mononitriles, such as acetonitrile and propionitrile, dinitriles such as glutaronitrile, and their derivatives. Sulfones include symmetric sulfones such as dimethyl sulfone, diethyl sulfone and the like, asymmetric sulfones such as ethyl methyl sulfone, propyl methyl sulfone and the like, and derivatives of such sulfones, especially fluorinated derivatives thereof. Sulfolanes include tetramethylene sulfolane and the like.

Other conductivity enhancing carbonates, which may be used, include fluorine containing carbonates, including difluoroethylene carbonate (DFEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, or any combination thereof.

Other conductivity enhancing additives, which may be used, include fluorinated oligomers, dimethoxyethane, triethylene glycol dimethyl ether (i.e., triglyme), tetraethyleneglycol, dimethyl ether (DME), polyethylene glycols, bromo γ-butyrolactone, fluoro γ-butyrolactone, chloroethylene carbonate, ethylene sulfite, propylene sulfite, phenylvinylene carbonate, catechol carbonate, vinyl acetate, dimethyl sulfite, or any combination thereof.

In some embodiments, the electrolyte solution comprises one or more alkali metal ion salts. Alkali metal ion salts that can be used in the embodiments described herein are also known or will be apparent to those skilled in the art. Any suitable salt can be used, including lithium salts, sodium salts, and potassium salts, that is, salts containing lithium or sodium or potassium as a cation, and an anion. Any suitable anion may be used, examples of which include, but are not limited to, boron tetrafluoride, (oxalate)borate, difluoro(oxalate)borate, phosphorus hexafluoride, alkylsulfonate, fluoroalkylsulfonate, arylsulfonate, bis(alkylsulfonyl)amide, perchlorate, bis(fluoroalkylsulfonyl)amide, bis(aryl sulfonyl)amide, alkyl, fluorophosphate, (fluoroalkylsulfonyl)(fluoroalkylcarbonyl)amide, halide, nitrate, nitrite, sulfate, hydrogen sulfate, alkyl sulfate, aryl sulfate, carbonate, bicarbonate, carboxylate, phosphate, hydrogen phosphate, dihydrogen phosphate, hypochlorite, an anionic site of a cation-exchange resin, and a mixture of any two or more thereof. For further examples, see, Zhang et al., U.S. Patent Application Publication No. 2012/0082903, which is incorporated by reference herein for its teachings thereof.

In some embodiments, the alkali metal salt comprises a lithium salt. In some aspects, the lithium salt comprises LiPF₆. In some other aspects, the alkali metal salt comprises LiTFSI. In some aspects, the alkali metal salt comprises a mixture of LiPF₆ and LITFSI. In some aspects, LiTFSI helps facilitate the dissolution of highly polar conductivity enhancing additives, such as ethylene carbonate when used in combination with the perfluoroalkanes described herein. Without being bound by any theory, it is thought that LiTFSI more completely disassociates, which increases the ionic strength of the electrolyte solution allowing for a more complete dissolution of polar compounds such as ethylene carbonate.

In some embodiments, the electrolyte compositions described herein comprise a viscosity reducer. Suitable, non-limiting examples of viscosity reducers include perfluorotetraglyme, γ-butyrolactone, trimethylphosphate, dimethyl methylphosphonate, difluoromethylacetate, fluoroethylene carbonate (FEC), vinylene carbonate (VC), etc.

In some embodiments, the electrolyte compositions described herein comprise a high voltage stabilizer. Suitable non-limiting examples of high voltage stabilizers include 3-hexylthiophene, adiponitrile, sulfolane, lithium bis(oxalato)borate, γ-butyrolactone, 1,1,2,2-tetrafluoro-3-(1,1,2,2-tetrafluoroethoxy)-propane, ethyl methyl sulfone, and trimethylboroxine.

In some embodiments, additional ingredients comprising PFPEs may be included in the electrolyte compositions described herein in any suitable amount, comprising from about 5% to about 60% of the electrolyte compositions described herein, including each integer within the specified range. See, International Patent Application Publication No. WO/2014204547, which is incorporated by reference in its entirety herein.

In some embodiments, the functionally substituted perfluoroalkanes described herein comprise about 30% to about 85%, or 40% to 85%, of the electrolyte compositions described herein. In some aspects, the functionally substituted perfluoroalkanes described herein comprise about 40% to about 50% of the electrolyte compositions described herein. In some aspects, the functionally substituted perfluoroalkanes described herein comprise about 50% to about 60% of the electrolyte compositions described herein. In some aspects, the functionally substituted perfluoroalkanes described herein comprise about 60% to about 70% of the electrolyte compositions described herein. In some aspects, the functionally substituted perfluoroalkanes described herein comprise about 70% to about 85% or more of the electrolyte compositions described herein. In some aspects, the functionally substituted perfluoroalkanes described herein comprise about 35%, about 40%, about 45%, about 50%, about 55%, about 60%, about 65%, about 70%, about 75%, about 80%, about 85%, or about 90% of the electrolyte compositions described herein.

In some embodiments, the alkali-metal salts described herein comprise about 8% to about 35%, or 15% to 35%, of the electrolyte compositions described herein. In some aspects, the functionally substituted perfluoroalkanes described herein comprise about 20% to about 30% of the electrolyte compositions described herein. In some aspects the alkali-metal salts described herein comprise about 10%, about 15%, about 20%, about 25%, about 30%, about 35%, or about 40% of the electrolyte compositions described herein.

In some embodiments, the optional one or more conductivity enhancing additives described herein comprise about 1% to about 40% of the electrolyte compositions described herein. In some aspects, the optional one or more conductivity enhancing additives described herein comprise about 10% to about 20% of the electrolyte compositions described herein. In some aspects, the optional one or more conductivity enhancing additives described herein comprise about 20% to about 30% of the electrolyte compositions described herein. In some aspects, the optional one or more conductivity enhancing additives described herein comprise about 30% to about 40% of the electrolyte compositions described herein. In some aspects, the optional one or more conductivity enhancing additives described herein comprise about 1%, about 2%, about 3%, about 4%, about 5%, about 10%, about 15%, about 20%, about 25%, about 30%, about 35%, about 40%, or about 45% of the electrolyte compositions described herein.

In some embodiments, the optional one or more SEI additives described herein comprise about 0.5% to about 6% of the electrolyte compositions described herein. In some aspects, the optional one or more SEI additives described herein comprise about 0.5%, about 1%, about 2%, about 3%, about 4%, about 5%, or about 6% of the electrolyte compositions described herein.

In some embodiments, the optional one or more viscosity reducers described herein comprise about 0.5% to about 6% of the electrolyte compositions described herein. In some aspects, the optional one or more viscosity reducers described herein comprise about 0.5%, about 1%, about 2%, about 3%, about 4%, about 5%, or about 6% of the electrolyte compositions described herein.

In some embodiments, the optional one or more high voltage stabilizers described herein comprise about 0.5% to about 6% of the electrolyte compositions described herein. In some aspects, the optional one or more high voltage stabilizers described herein comprise about 0.5%, about 1%, about 2%, about 3%, about 4%, about 5%, or about 6% of the electrolyte compositions described herein.

In some embodiments, the optional one or more wettability additives described herein comprise about 0.5% to about 6% of the electrolyte compositions described herein. In some aspects, the optional one or more wettability additives described herein comprise about 0.5%, about 1%, about 2%, about 3%, about 4%, about 5%, or about 6% of the electrolyte compositions described herein.

In some embodiments, the optional one or more flame retardant additives described herein comprise about 0.5% to about 25% of the electrolyte compositions described herein. In some aspects, the optional one or more wettability additives described herein comprise between about 5% and 20%, pr between about 5% and 15% of the electrolyte compositions described herein.

Flammability of an electrolytic compound or mixture thereof may be characterized by flash points (FPs) or self-extinguishing times (SETs). The flash point of a liquid is the lowest temperature at which vapors of the fluid ignite and is measured by subjecting the liquid to an ignition source as temperature is raised. The flash point may be tested by using an instrument, such as the Koehler rapid flash tester, or an equivalent, wherein a composition is subjected to an ignition source for at least about 1 second to about 30 seconds at a temperature range of from about −30° C. to about 300° C. The SET of a sample is the time that an ignited sample keeps burning. In some cases, a liquid may have a flash point but a SET of zero, indicating that the material flashes but does not burn once the ignition source is removed.

Heavily fluorinated compounds are inherently non-flammable. This is distinct from conventional electrolyte flame retardant additives such as phosphates, which retard combustion by scavenging free radicals, thereby terminating radical chain reactions of gas-phase combustion.

As described above, in some embodiments, the electrolytes disclosed herein have a fluoropolymer or mixture of fluoropolymers as the largest component by weight. This is distinct from fluorinated additives present in small amounts with non-fluorinated hydrocarbon or other conventional solvent as the largest component of the solvent.

In some aspects, the electrolyte compositions described herein comprise the solvent system shown in Table 2. It should be noted that the solvent systems in Table 2 do not include salts or optional SEI additives, which may be added to the solvent to form an electrolyte.

TABLE 2
Example Fluoropolymer Electrolyte Solvent System

| | | Composition Ranges |
|---|---|---|
| Component | Example Components | (wt %) |
| Func. Subst. PFA or | PFA-carbonate (e.g., PFA-methyl carbonate), | 40-100 |
| mixture of Func. Subst. | etc. | 50-90 |
| PFA's | | 55-85 |
| | | 60-70 |
| C1-C10 cycloalkyl | Ethylene carbonate, propylene carbonate | 0-40 |
| carbonate or mixture | | 5-30 |
| thereof | | 10-30 |
| | | 15-30 |
| Opt. Conductivity | Trispentafluorophenyl borane, lithium | 0.5-35 |
| Additive(s), Opt. | bis(oxalato)borate, γ-butyrolactone, | 0.5-25 |
| Viscosity reducer(s), | perfluorotetraglyme, dimethyl | 0.5-6 |
| Opt. High voltage | methylphosphonate, | |
| stabilizer(s), Opt. | difluoromethylacetate, fluoroethylene | |
| Wettability additive(s), | carbonate (FEC), vinylene carbonate | |
| Opt. Flame retardants | (VC), 3-hexylthiophene, adiponitrile, | |
| | sulfolane, lithium bis(oxalato)borate, γ- | |
| | butyrolactone, 1,1,2,2-tetrafluoro-3- | |
| | (1,1,2,2-tetrafluoroethoxy)-propane, ethyl | |
| | methyl sulfone, trimethylboroxine, non- | |
| | ionic or ionic surfactant, fluorosurfactant, | |
| | trimethylphosphate, triethylphosphate, | |
| | triphenyl phosphate, etc. | |

In some embodiments, the electrolyte solvent includes a functionally substituted PFPE as the largest component by weight and also includes a significant amount of a C1-C10 cyclo alkyl carbonate. For example, the electrolyte solvent may include at least 5% by weight, or greater than 5% by weight, of C1-C10 cyclo alkyl carbonate such as ethylene carbonate (EC), propylene carbonate and the like. In some embodiments, the electrolyte includes at least 5% of a C1-C10 or C1-C5 cycloalkyl carbonate. In some embodiments, the electrolyte includes at least 10% of a C1-C10 or C1-C5 cycloalkyl carbonate. In some embodiments, the electrolyte includes at least 15% of a C1-C10 or C1-C5 cycloalkyl carbonate. In some embodiments, the electrolyte includes at least 20% of a C1-C10 or C1-C5 cycloalkyl carbonate. In addition to being a conductivity enhancer, the cyclo alkyl carbonate may aid formation of a stable SEI layer. While EC and other cyclo alkyl carbonates have relatively high FPs, the SETs are also high; once ignited, EC will burn until it is consumed.

The PFA's disclosed herein may have no or very high flash points. The electrolyte solvent including additives will generally have a flash point due to the presence of the additives. In some embodiments, the electrolyte compositions described herein are non-flammable with a flash point of about 50° C. to about 275° C. In some aspects, the electrolyte compositions described herein are non-flammable with a flashpoint greater than about 50° C., greater than about 60° C., greater than about 70° C., greater than about 80° C., greater than about 90° C., greater than about 100° C., greater than about 110° C., greater than about 120° C., greater than about 130° C., greater than about 140° C., greater than about 150° C., greater than about 160° C., greater than about 170° C., greater than about 180° C., greater than about 190° C., greater than about 200° C., greater than about 200° C., greater than about 210° C., greater than about 220° C., greater than about 230° C., greater than about 240° C., greater than about 250° C., greater than about 260° C., greater than about 270° C., or greater than about 280° C. It is understood that an electrolyte composition having a flash point greater than a certain temperature includes compositions that do not flash at all and have no flash point.

In addition to the flash points described above, the electrolyte compositions may have SETs of less than one second, or zero.

In some embodiments, each component of the electrolyte mixture that is present at greater than 5% of the solvent has a flash point of at least 80° C., or at least 90° C., or at least 100° C. The corresponding electrolyte mixture may have a flash point of greater than 100° C., or greater than 110° C., or greater than 120° C., along with an SET of zero.

In some embodiments, the non-flammable liquid or solid electrolyte compositions described herein have an ionic conductivity of from 0.01 mS/cm to about 10 mS/cm at 25° C. In some embodiments, the non-flammable liquid or solid electrolyte compositions described herein have an ionic conductivity of from 0.01 mS/cm to about 5 mS/cm at 25° C. In some embodiments, the non-flammable liquid or solid electrolyte compositions described herein have an ionic conductivity of from 0.01 mS/cm to about 2 mS/cm at 25° C. In some embodiments, the non-flammable liquid or solid electrolyte compositions described herein have an ionic conductivity of from 0.1 mS/cm to about 5 mS/cm at 25° C. In some embodiments, the non-flammable liquid or solid electrolyte compositions described herein have an ionic conductivity of from 0.1 mS/cm to about 2 mS/cm at 25° C.

### Alkali Metal Batteries

An alkali metal ion battery (sometimes also referred to as alkali metal batteries, and including alkali metal-air batteries) of the present invention generally includes (a) an anode; (b) a cathode; (c) a liquid or solid electrolyte composition as described above operatively associated with the anode and cathode, and (d) optionally a separator for physically separating the anode and cathode (See, e.g., M. Armand and J.-M. Tarascon, Building Better Batteries, Nature 451, 652-657 (2008)). In addition, alkali metal batteries may further comprise one or more current collectors at the cathode and anode. Examples of suitable battery components include but are not limited to those described in U.S. Pat. Nos. 5,721,070; 6,413,676; 7,729,949; and in U.S. Patent Application Publication Nos. 2009/0023038; 2011/0311881; and 2012/0082930; and S.-W. Kim et al., Adv. Energy Mater. 2, 710-721 (2012), each of which is incorporated by reference herein for their teachings thereof.

Examples of suitable anodes include but are not limited to, anodes formed of lithium metal, lithium alloys, sodium metal, sodium alloys, carbonaceous materials such as graphite, and combinations thereof. Examples of suitable cathodes include, but are not limited to cathodes formed of transition metal oxides, doped transition metal oxides, metal phosphates, metal sulfides, lithium iron phosphate, and combinations thereof. See, e.g., U.S. Pat. No. 7,722,994. Additional examples include but are not limited to those described in Zhang et al., U.S. Pat. App. Pub No. 2012/0082903, at paragraphs 178 to 179, which is incorporated by reference herein for its teachings thereof. In some embodiments, an electrode such as a cathode can be a liquid electrode, such as described in Y. Lu et al., J Am. Chem. Soc. 133, 5756-5759 (2011), which is incorporated by reference herein for its teachings thereof. Numerous carbon electrode materials, including but not limited to carbon foams, fibers, flakes, nanotubes and other nanomaterials, etc., alone or as composites with each other or other materials, are known and described in, for example, U.S. Pat. Nos. 4,791,037; 5,698,341; 5,723,232; 5,776,610; 5,879,836; 6,066,413; 6,146,791; 6,503,660; 6,605,390; 7,071,406; 7,172,837; 7,465,519; 7,993,780; 8,236,446, and 8,404,384, each of which is incorporated by reference herein for its teachings thereof. In an alkali metal-air battery such as a lithium-air battery, sodium-air battery, or potassium-air battery, the cathode is preferably permeable to oxygen (e.g., where the cathode comprises mesoporous carbon, porous aluminum, etc.), and the cathode may optionally contain a metal catalyst (e.g., manganese, cobalt, ruthenium, platinum, or silver catalysts, or combinations thereof) incorporated therein to enhance the reduction reactions occurring with lithium ion and oxygen at the cathode. See, e.g., U.S. Pat. No. 8,012,633 and U.S. Patent Application Publication Nos. 2013/0029234; 2012/0295169; 2009/0239113; see also P. Hartmann et al., A rechargeable room-temperature sodium superoxide (NaO₂) battery, Nature Materials 12, 228-232 (2013), each of which is incorporated by reference herein for its teachings thereof.

Where the electrolyte composition is a liquid composition, a separator formed from any suitable material permeable to ionic flow can also be included to keep the anode and cathode from directly electrically contacting one another. Examples of suitable separators include, but are not limited to, porous membranes or films formed from organic polymers such as polypropylene, polyethylene, etc., including composites thereof. See, generally P. Arora and Z. Zhang, Battery Separators, Chem. Rev. 104, 4419-4462 (2004), which is incorporated by reference herein for its teachings thereof. When the electrolyte composition is a solid composition, particularly in the form of a film, it can serve as its own separator. Such solid film electrolyte compositions of the present invention may be of any suitable thickness depending upon the particular battery design, such as from 0.01, 0.02, 0.1 or 0.2 microns thick, up to 1, 5, 7, 10, 15, 20, 25, 30, 40 or 50 microns thick, or more.

The alkali metal batteries described herein may also include one or more current collectors at the cathode and one or more current collectors at the anode. Suitable current collectors function to transfer a large current output while having low resistance. Current collectors described herein may be in the form of a foil, mesh, or as an etching. Furthermore, a current collector may be in the form of a microstructured or a nanostructured material generated from one or more suitable polymers. In some aspects, the current collectors may be aluminum (Al) at the cathode and copper (Cu) at the anode.

All components of the battery can be included in or packaged in a suitable rigid or flexible container with external leads or contacts for establishing an electrical connection to the anode and cathode, in accordance with known techniques.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the specified embodiments. All of the various embodiments, aspects, and options disclosed herein can be combined in all variations. The scope of the compositions, formulations, methods, and processes described herein include all actual or potential combinations of embodiments, aspects, options, examples, and preferences herein described. All patents and publications cited herein are incorporated by reference herein for the specific teachings thereof.

### EXAMPLES

### Example 1

### Synthesis of Functionally Substituted Perfluoroalkanes

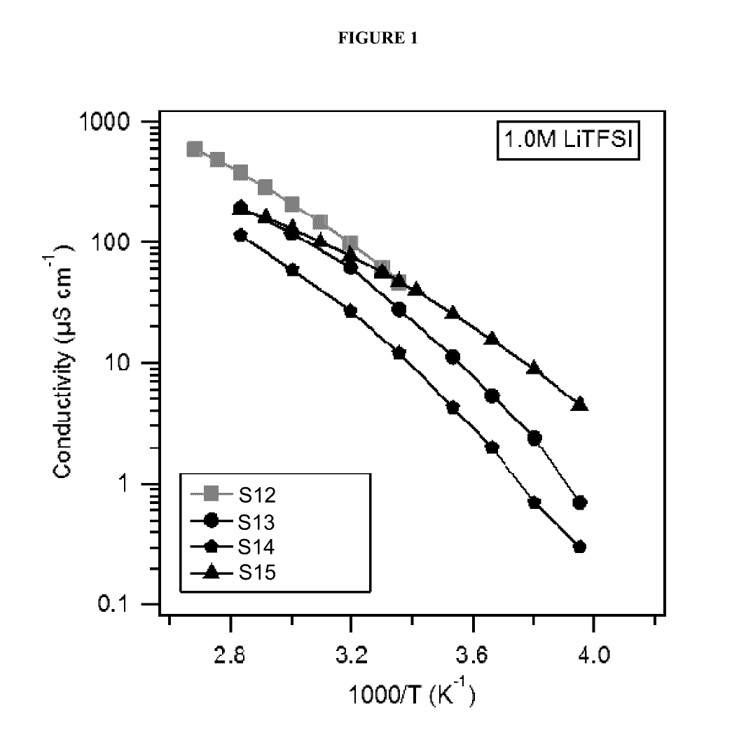

The structure according to S15; 2,2,3,3,4,4,5,5,6,6,7,7,7-Tridecafluoroheptyloxy acetate (also referred to in FIGS. 1-3 as hexyl-mMe) was generated as described by the following method. To a 250 mL reaction vessel under nitrogen was added 20.0 g 1H,1H-perfluoro-1-heptanol, 8.40 mL trimethylamine and 60 mL 1,1,1,3,3-pentafluorobutane. All components were previously dried over activated molecular sieves. The reaction vessel was cooled on an ice water bath and over the course of one hour 5.70 g of methyl chloroformate was added dropwise. The reaction vessel was removed from the ice bath and allowed to stir for an additional four hours. The triethylammonium hydrochloride produced during the reaction was removed by filtration. The resulting solution was washed with dilute HCl and deionized water using a separatory funnel and the fluoro-organic phase was dried with magnesium sulfate, filtered and the solvent removed by rotary evaporation. The resulting liquid was purified by vacuum distillation to yield a 18.7 g (80.3%) of the compound.

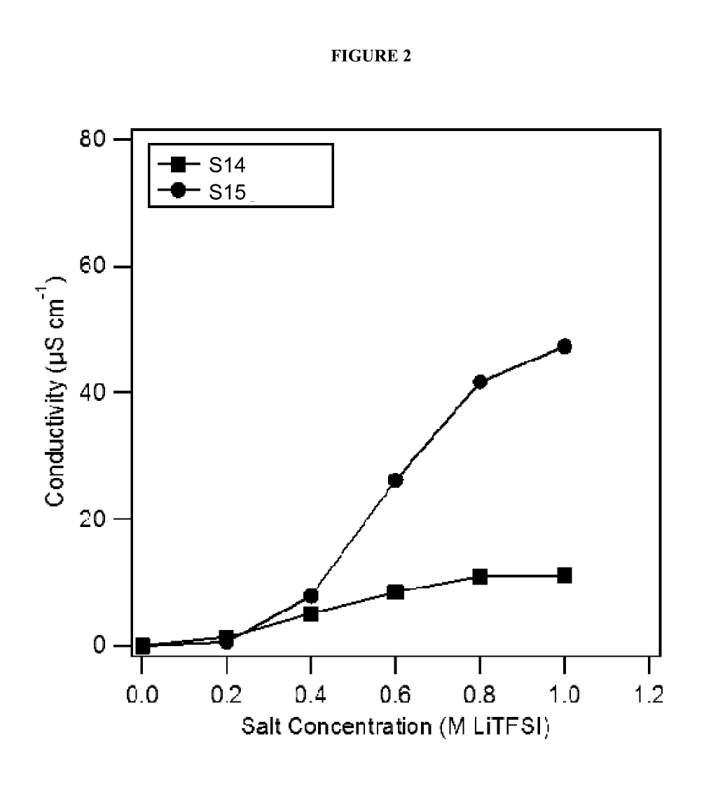

The structure according to S14; 2,2,3,3,4,4,5,5,6,6,7,7-Didecafluoro-8-(methoxycarbonyloxy)octyloxy acetate (also referred to in FIGS. 1 and 2 as hexyl-dMe) was generated by the following method. To a 250 mL reaction vessel under nitrogen was added 24.7 g 1H,1H,8H,8H-perfluoro-1,8-octanediol, 21.0 mL trimethylamine and 200 mL 1,1,1,3,3-pentafluorobutane. All components were previously dried over activated molecular sieves. The reaction vessel was cooled in an ice water bath and over the course of one hour 13.5 g of methyl chloroformate was added dropwise. The reaction vessel was removed from the ice bath and allowed to stir for an additional four hours. The triethylammonium hydrochloride produced during the reaction was removed by filtration. The resulting solution was washed with dilute HCl and deionized water using a separatory funnel and the fluoro-organic phase was dried with magnesium sulfate, filtered and the solvent removed by rotary evaporation. The resulting liquid was purified by vacuum distillation to yield 18.3 g (56%) of the compound.

The structure according to S19; 4-[(1H,1H-perfluoroheptyloxy)methyl]-1,3-dioxolan-2-one was synthesized by the following method. To a 100 mL reaction vessel under nitrogen was added 25.0 g 1H,1H-perfluoro-1-heptanol, 66.1 g epichlorohydrin, and 2.86 g NaOH. The mixture was stirred at 60° C. overnight and then cooled to room temperature. The excess epichlorohydrin was then removed under vacuum. Ethyl acetate and DI water in an amount of 100 mL each was then added and the two layers were then separated. The organic mixture was washed twice with DI water, dried with magnesium sulfate and filtered; the ethyl acetate was removed by rotary evaporation. The intermediate functionalized epoxide was purified by vacuum distillation. This clear, colorless, oil was dissolved in 20 mL of 1-methoxy-isopropanol with 0.55 g methyltriphenylphosphonium iodide in a 250 mL reaction vessel attached to a balloon. The vessel was purged with CO₂ and then pressurized so that the balloon was fully inflated. The reaction was stirred for four days at room temperature, periodically re-pressurizing the balloon as needed. At the end of the reaction 100 mL each 1,1,1,3,3-pentafluorobutane and DI water was added and the layers separated. The fluoro-organic layer was then further washed with two portions of DI water, dried with magnesium sulfate and filtered, and the solvent was removed by rotary evaporation. The product was purified by fractional distillation under vacuum to give a clear colorless oil.

### Example 2

### Electrochemical Measurements

The conductivity of electrolyte solutions and cyclic voltammetry measurements of perfluoroalkane based electrolyte solutions were determined experimentally using similar methods as described by Teran et al., Solid State Ionics (2011) 203, p. 18-21; Lascaud et al., Maromolecules (1994) 27 (25); and International Patent Application Publication Nos. WO2014/204547 and WO2014/062898, each of which are incorporated by reference herein for their teachings thereof.

### Example 3

### Temperature-Dependent Ionic Conductivity of Perfluoroalkane Based Electrolyte Solutions

As shown in FIG. 1, the conductivity of electrolyte solutions containing a linear carbonate terminated perfluoroalkane according to structures S12-S15 and 1.0M LiTFSI decreases across a range of temperatures.

### Example 4

### Ionic Conductivity of Perfluoroalkane Based Electrolyte Solutions

The conductivity of several perfluoroalkanes according to structures S14 and S15 as a function of LiTFSI salt concentration was measured. As shown in FIG. 2, the conductivity increases with increasing LiTFSI content.

### Example 5

### Cyclic Voltammetry of Perfluoroalkane Based Electrolyte Solutions

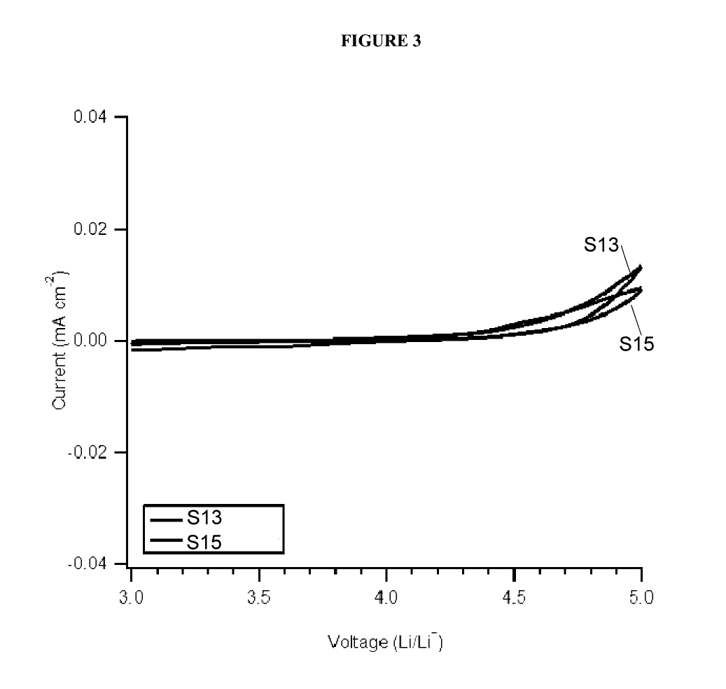

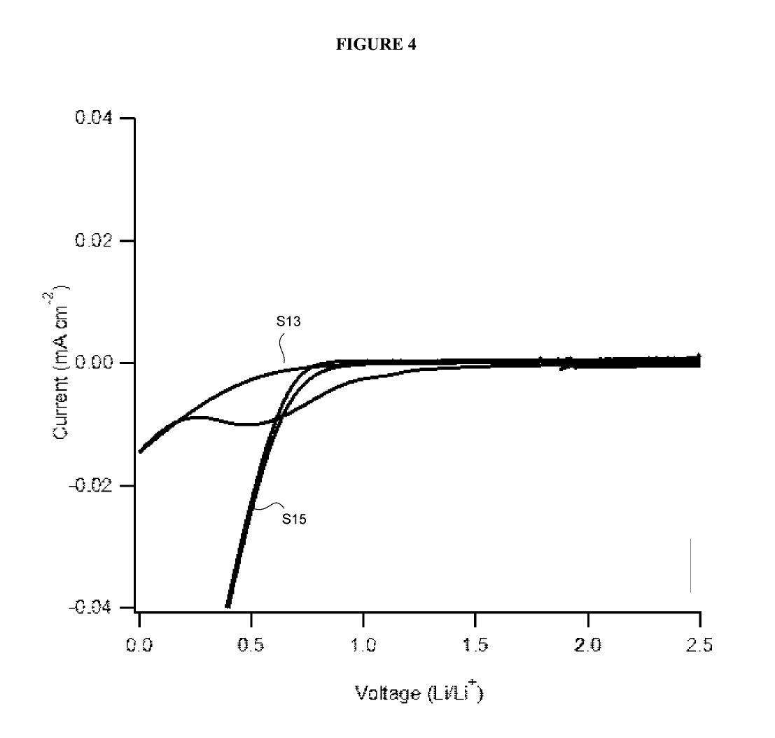

Cyclic voltammetry measurements of several perfluoroalkanes according to structures S13 and S15 with 1.0 M LiTFSI was tested. FIG. 3 shows the anodic scan on a Pt working electrode at 25° C. and FIG. 4 shows the cathodic scan on a glassy carbon working electrode at 25° C.

### Example 6

### Conductivities, Flash Points, and Viscosities of PFA's

Flash point, conductivity and viscosity of linear PFA-carbonates of various sizes were measured.

| | Mono- | | | | | Conductivity |
|---|---|---|---|---|---|---|
| | or di- | | | | Flash | 1.0M LiTFSI |
| Mole- | func- | | MW of | Viscosity | Point | @ 25° C. |
| cule | tional | MW | R_{f} | (cP) at 20° C. | (° C.) | (mS/cm) |
| S12 | di | 278 | 100 | n/a (melting | 154 | 0.05 |
| | | | | point is 52° C.) | | |
| S13 | di | 378 | 200 | 36 | 168 | 0.03 |
| S14 | di | 478 | 250 | 61 | None | 0.01 |
| S15 | mono | 408 | 269 | 5.3 | None | 0.05 |

S14 and S15 are directly comparable, with S15 being the mono-functional version of S14. The conductivity of S15 is five times that of S14.

What is claimed is:

1. A non-flammable electrolyte composition comprising an alkali metal salt and an electrolyte solvent comprising a functionalized perfluoroalkane according to Formula I or Formula II:
R_{f}—Xₒ—R′ (I)
R″—Xₘ—R_{f}—Xₒ—R′ (II)
wherein ‘R_{f}’ is a perfluoroalkane backbone;
X is an alkyl, fluoroalkyl, ether, or fluoroether group, wherein ‘m’ and ‘o’ are each independently zero or an integer ≧1; and
R″ and R′ are each independently selected from the group consisting of aliphatic, alkyl, aromatic, heterocyclic, amide, carbamate, carbonate, sulfone, phosphate, phosphonate, and nitrile containing groups.

2. The electrolyte composition according to claim 1, wherein said functionalized perfluoroalkane has a number average molecular weight of about 150 g/mol to about 5,000 g/mol.

3. The electrolyte composition according to claim 1, wherein X comprises an alkyl group.

4. The electrolyte composition according to claim 1, wherein the one or more carbonate containing groups comprises one or more linear carbonate groups.

5. The functionalized perfluoroalkane of claim 4, wherein at least one of the one or more linear carbonate groups comprises structure S1, 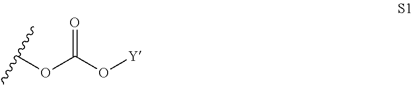
wherein Y′ is selected from the group consisting of aliphatic, alkyl, aromatic, heterocyclic, amide, carbamate, carbonate, sulfone, phosphate, phosphonate, or nitrile containing groups.

6. The electrolyte composition according to claim 1, wherein the functionalized perfluoroalkane is selected from the group consisting of structures S12-S15,

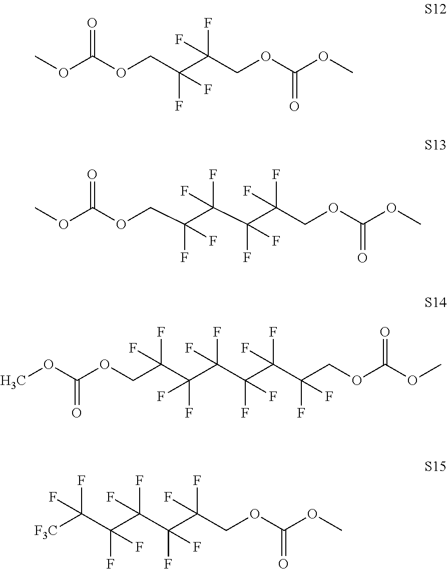

7. The electrolyte composition according to claim 1, wherein the one or more carbonate containing groups comprises one or more cyclic carbonate groups. 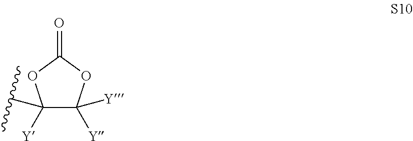
wherein Y′, Y″, and Y′″ are each selected from the group consisting of aliphatic, alkyl, aromatic, heterocyclic, amide, carbamate, carbonate, sulfone, phosphate, phosphonate, or nitrile containing groups, or a hydrogen atom or a halogen atom.

8. The electrolyte composition according to claim 1, wherein the functionalized perfluoroalkane comprises from about 30% to about 85% of the non-flammable liquid or solid electrolyte composition.

9. The electrolyte composition according to claim 1, wherein the alkali metal salt comprises a lithium salt or a sodium salt.

10. The electrolyte composition according to claim 9, wherein the alkali metal salt is a lithium salt comprising LiPF₆ or LiTFSI or a mixture thereof.

11. The electrolyte composition according to claim 10, wherein LiPF₆ or LiTFSI or a mixture thereof comprises about 8% to about 35% of the non-flammable liquid or solid electrolyte composition.

12. The electrolyte composition according to claim 1, further comprising at least one of a conductivity enhancing additive viscosity reducer, a high voltage stabilizer, or a wettability additive, or a mixture or combination thereof.

13. The electrolyte composition of claim 12, wherein the conductivity enhancing additive comprises ethylene carbonate (EC), propylene carbonate (PC), butylene carbonate (BC), fluoroethylene carbonate, vinylene carbonate (VC), dimethylvinylene carbonate (DMVC), vinylethylene carbonate (VEC), divinylethylene carbonate, phenylethylene carbonate, or diphenylethylene carbonate, or a mixture or combination thereof.

14. The electrolyte composition of claim 12, wherein the conductivity enhancing agent comprises ethylene carbonate.

15. The electrolyte composition of claim 12, wherein the conductivity enhancing additive comprises about 1% to about 40% of the non-flammable liquid or solid electrolyte composition.

16. The electrolyte composition of claim 12, wherein the high voltage stabilizer comprises 3-hexylthiophene, adiponitrile, sulfolane, lithium bis(oxalato)borate, γ-butyrolactone, 1,1,2,2-Tetrafluoro-3-(1,1,2,2-tetrafluoroethoxy)-propane, ethyl methyl sulfone, or trimethylboroxine or a mixture or combination thereof.

17. The electrolyte composition of claim 12, wherein the wettability additive comprises triphenyl phosphite, dodecyl methyl carbonate, methyl 1-methylpropyl carbonate, methyl 2,2-dimethylpropanoate, or phenyl methyl carbonate or a mixture or combination thereof.

18. The electrolyte composition of claim 12, wherein the viscosity reducer, high voltage stabilizer, and wettability additive each independently comprise about 0.5-6% of the non-flammable liquid or solid electrolyte composition.

19. The electrolyte composition according to claim 1, wherein said composition has an ionic conductivity of from 0.01 mS/cm to about 10 mS/cm at 25° C.

20. The electrolyte composition according to claim 1, wherein said composition does not ignite when heated to a temperature of about 150° C. and subjected to an ignition source for at least 15 seconds.

21. A battery comprising:
(a) an anode;
(b) a separator;
(c) a cathode; and
(d) the non-flammable electrolyte composition according to claim 1.

22. A method of making the functionalized perfluoroalkane having one or more linear carbonate groups comprising the steps of:
(a) flushing a reaction vessel with a gas comprising an inert gas;
(b) adding a hydroxyl terminated perfluorocarbon, trimethylamine, and 1,1,1,3,3-pentafluorobutane or tetrahydrofuran to said reaction vessel, wherein trimethylamine is present as one equivalent per hydroxyl group;
(c) mixing the solution resulting from steps (a) and (b) and adding methyl chloroformate to form said perfluoroalkane having one or more linear carbonate groups; and
(d) isolating said perfluoroalkane having one or more linear carbonate groups.

23. The method of making the functionalized perfluoroalkane according to claim 22 further comprising the steps of:
(a) adding a hydroxyl terminated perfluorocarbon, sodium hydroxide and epichlorohydrin to a reaction vessel, wherein sodium hydroxide is present as one equivalent per hydroxyl group to form a mixture;
(b) heating the mixture of step (a) to 60° C. and incubating said mixture at 60° C. overnight to form an epoxide terminated perfluorocarbon;
(c) isolating the epoxide terminated perfluorocarbon of step (b);
(d) adding the isolated epoxide terminated perfluorocarbon of step (c) to a reaction vessel comprising a mixture comprising: methyltriphenylphosphonium iodide or phosphonium iodide; and (ii) 1-methoxy-isopropanol or isopropanol;
(e) pressurizing the reaction vessel of step (d) with carbon dioxide to form the cyclic carbonate terminated perfluoroalkane; and
(f) isolating the cyclic carbonate terminated perfluoroalkane.
